(19) United States
(12) Patent Application Publication
(10) Pub. No.: US 2025/0048092 A1
(43) Pub. Date: Feb. 6, 2025

(54) METHOD AND APPARATUS FOR SYNCHRONIZING KEYS IN SELECTIVE SCG

(71) Applicant: SAMSUNG ELECTRONICS CO., LTD., Suwon-si (KR)

(72) Inventors: Hongjin CHOI, Suwon-si (KR); Taehyung LIM, Suwon-si (KR)

(21) Appl. No.: 18/795,001

(22) Filed: Aug. 5, 2024

(30) Foreign Application Priority Data
Aug. 4, 2023 (KR) 10-2023-0102082
Oct. 27, 2023 (KR) 10-2023-0145772
Feb. 21, 2024 (KR) 10-2024-0024822

(51) Int. Cl. H04W 12/043; H04L 5/00; H04W 12/106; H04W 76/20

(52) U.S. Cl. CPC H04W 12/043; H04L 5/0053; H04W 12/106; H04W 76/20

(57) ABSTRACT

The disclosure relates to a 5G or 6G communication system for supporting a higher data transmission rate. A method and apparatus of a master node (MN) are provided. The method of MN comprises: transmitting, to at least one target secondary node (SN), an SN addition request message including at least one SN counter value and K_{SN} key corresponding to each target SN, wherein each target SN includes a first target SN and a second target SN; transmitting, to a user equipment (UE), a first radio resource control (RRC) reconfiguration message including the at least one SN counter value and the K_{SN} key corresponding to each target SN; and transmitting, to the first target SN, an SN reconfiguration complete message including an SN counter value received from the UE.

### CROSS-REFERENCE TO RELATED APPLICATIONS

This application is based on and claims priority under 35 U.S.C. § 119 to Korean Patent Application Nos. 10-2023-0102082, 10-2023-0145772, and 10-2024-0024822 filed on Aug. 4, 2023, Oct. 27, 2023, and Feb. 21, 2024, in the Korean Intellectual Property Office, the disclosure of which are incorporated by reference herein in their entirety.

### BACKGROUND

### 1. Field

The disclosure relates to a wireless communication system. More particularly, the disclosure relates to a method and apparatus for managing keys when a terminal is in dual connectivity in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure aims to provide a method and apparatus for synchronizing security keys between the terminal and the secondary node (SN) when the terminal makes repeated conditional SN changes. More specifically, the disclosure is to solve the problem of synchronizing the keys used between the terminal and the secondary node (SN) when the terminal receives multiple SN counter values per SN from the MN during repeated conditional SN changes (selective SCG).

The technical objectives to be achieved in embodiments of the disclosure are not limited to those mentioned above, and other technical objectives not mentioned will be clearly understood by those skilled in the art to which the disclosure belongs from the following description.

According to an embodiment of the disclosure, it is possible to provide an apparatus and method that can effectively provide services in a wireless communication system.

The effects that can be obtained from the disclosure are not limited to those mentioned in various embodiments, and other effects not mentioned will be clearly understood by those skilled in the art to which the disclosure belongs from the following description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,”. “is” inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a communication network according to an embodiment of the disclosure;

FIG. 1B illustrates a wireless environment including a core network in a wireless communication system according to an embodiment of the disclosure;

FIG. 2A illustrates a functional structure of a UE according to an embodiment of the disclosure;

FIG. 2B illustrates a functional structure of a base station according to an embodiment of the disclosure;

FIG. 2C illustrates a functional structure of a core network entity according to an embodiment of the disclosure;

FIG. 3A illustrates a process for synchronizing security keys according to an embodiment of the disclosure;

FIG. 3B illustrates a process for synchronizing security keys according to an embodiment of the disclosure;

FIG. 4A illustrates a process for synchronizing security keys according to another embodiment of the disclosure; and

FIG. 4B illustrates a process for synchronizing security keys according to another embodiment of the disclosure.

### DETAILED DESCRIPTION

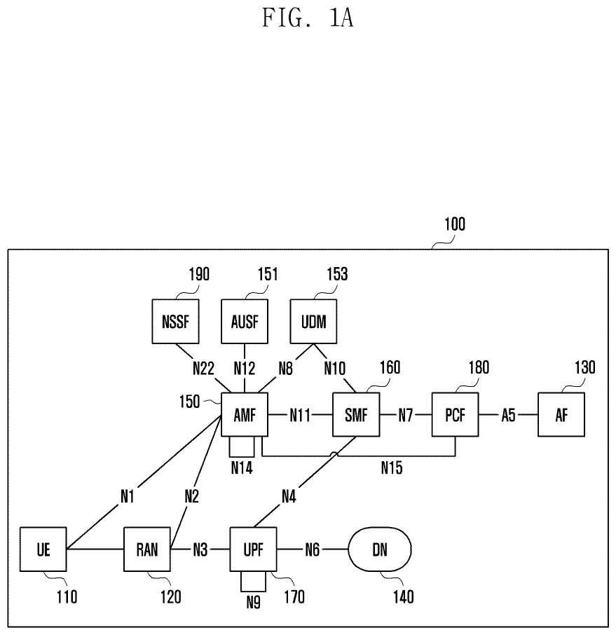

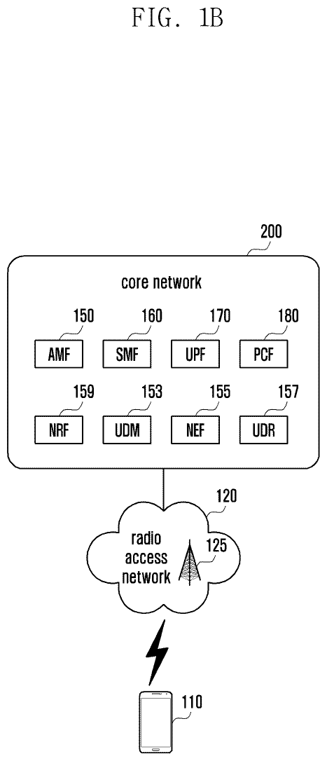

FIGS. 1 through 4B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Terms used in the disclosure may be used to describe specific embodiments and are not intended to limit the scope of other embodiments. Singular expressions may include plural expressions unless the context clearly dictates otherwise. Terms used herein, including technical or scientific terms, may have the same meaning as commonly understood by a person of ordinary skill in the technical field described in this disclosure. Among the terms used in this disclosure, terms defined in general dictionaries may be interpreted to have the same or similar meaning as the meaning they have in the context of related technology, and are not to be construed in an idealized or overly formal sense unless explicitly defined in the disclosure. In some cases, even terms defined in the disclosure cannot be interpreted to exclude specific embodiments of the disclosure.

In various embodiments of the disclosure described below, hardware-based approaches are described as an example. However, since various embodiments of the disclosure include technology using both hardware and software, the various embodiments of the disclosure do not exclude software-based approaches.

To evolve from the existing 4G LTE system to the 5G system, 3GPP in charge of cellular mobile communication standards has named a new core network architecture as 5G core (5GC) and is in the process of standardization. Compared to the evolved packet core (EPC) being the core for the existing 4G network, the 5GC supports the following differentiated functions.

First, a network slice functionality is introduced in the 5GC. As 5G requirements, the 5GC should support various types of terminals and services, such as enhanced mobile broadband (eMBB), ultra-reliable low-latency communications (URLLC), and massive machine type communications (mMTC).

Such various types of services have different requirements for the core network. For example, an eMBB service requires a high data rate, and a URLLC service requires high stability and low latency. One of the techniques provided to meet such various service requirements is network slicing.

Network slicing is a way to create multiple logical networks through virtualization of a single physical network, and individual network slice instances (NSIs) may have different characteristics. Hence, various service requirements can be satisfied by having a network function (NF) suitable for the characteristic of each NSI. Various 5G services can be efficiently supported by allocating an NSI suitable for the characteristic of a service required by each terminal.

Second, the 5GC can facilitate the support of the network virtualization paradigm by separating the mobility management function and the session management function. In 4G long term evolution (LTE), services may be provided through signaling exchange with a single core equipment called mobility management entity (MME) that takes charge of registration, authentication, mobility management, and session management functions for all terminals. However, in 5G, as the number of terminals increases explosively and the mobility and traffic/session characteristics to be supported are subdivided according to the types of terminals, if all functions are supported by a single equipment such as the MME, the scalability of adding an entity for each required function is inevitably reduced. Hence, to improve scalability in terms of function/implementation complexity and signaling load of the core equipment in charge of the control plane, various functions are being developed based on the structure separating the mobility management function and the session management function.

Hereinafter, various embodiments will be described in detail with reference to the accompanying drawings. In the description of the disclosure, descriptions of well-known functions and structures incorporated herein may be omitted to avoid obscuring the subject matter of the disclosure. Also, the terms described below are defined in consideration of their functions in the disclosure, and these may vary depending on the intention of the user, the operator, or the custom. Hence, their meanings should be determined based on the overall contents of this specification.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit,” “module,” or the like used in various embodiments of the disclosure may refer to a software component or a hardware component such as an FPGA or ASIC capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Components and units may be implemented to drive one or more processors in a device or a secure multimedia card.

In the following description, a base station, as a main entity that performs resource allocation to UEs, may be at least one of eNode B (eNB), Node B, base station (BS), radio access network (RAN), access network (AN), RAN node, NR NB, gNB, radio access unit, base station controller, or network node.

A terminal may include a user equipment (UE), a mobile station (MS), a cellular phone, a smartphone, a computer, or a multimedia system capable of performing communication functions. In various embodiments of the disclosure, the case where the terminal is a LUE will be described as an example. Additionally, a system based on LTE, LTE-A, or NR will be described as an example in various embodiments of the disclosure, but various embodiments of the disclosure may also be applied to other communication systems with similar technical backgrounds or channel configurations. In addition, as those skilled in the art will understand, various embodiments of the disclosure can be applied to other communication systems through some modifications without significantly departing from the scope of the disclosure.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

Additionally, in the disclosure, various embodiments are described utilizing terms used in some communication standards (e.g., 3rd Generation Partnership Project (3GPP)), but this is only an illustration for explanation. Various embodiments of the disclosure may be easily modified and applied to other communication systems. Next, some terms used in the core network of the disclosure are defined in advance:
AMF Access and Mobility Management Function;
CN Core Network;
CNF Containerized Network Function;
DNN Data Network Name;
PCF Policy Control Function;
HSS Home Subscriber Server;
SMF Session Management Function;
UDM User Data Management;
UPF User Plane Function;
CNF Containerized Network Function; and
VNF Virtual Network Function.

According to various embodiments of the disclosure, a method performed by a UE may include: receiving, from an MN, an indication indicating whether the MN supports selective SCG; transmitting, to the MN, an indication indicating whether the UE supports selective SCG; storing and managing SN counter(s) received from the MN; notifying the MN of an SN counter value used by the UE to use a key; and after using the SN counter value for key generation, adding 1 to the SN counter value and storing the result as a new SN counter.

According to various embodiments of the disclosure, a method performed by a base station in a wireless communication system may include: transmitting, by an MN to a UE, an indication indicating whether the MN supports selective SCG; receiving an indication indicating whether the UE supports selective SCG from the UE; determining, by the MN, whether to generate a K_{SN} before transmitting an SN addition request message to an SN; determining, by the MN, whether to transmit an SN counter when transmitting an RRC connection reconfiguration message to the UE; determining, by the MN, the number of SN Counters to be transmitted when transmitting the RRC connection reconfiguration message to the UE; receiving an SN counter used for K_{SN} generation from the UE; and after using an SN counter value for key generation, adding 1 to the SN counter value and storing the result as a new SN counter.

FIG. 1A illustrates a communication network according to an embodiment of the disclosure.

More specifically, FIG. 1A illustrates a communication network including core network entities in a wireless communication system according to various embodiments of the disclosure. A 5G mobile communication network may be composed of a 5G user equipment (UE) 110, a 5G radio access network (RAN) 120, and a 5G core network.

The 5G core network may be composed of network functions such as access and mobility management function (AMF) 150 providing a mobility management function to the UE, session management function (SMF) 160 providing a session management function, user plane function (UPF) 170 providing a data transfer role, policy control function (PCF) 180 providing a policy control function, unified data management (UDM) (153) providing a data management function for subscriber data and policy control data, or unified data repository (UDR) storing data of various network functions.

With reference to FIG. 1A, the user equipment (UE) 110 may communicate through a radio channel formed with a base station (e.g., eNB, gNB), that is, an access network. In some embodiments, the UE 110 may be a device used by a user and may be a device configured to provide a user interface (UI). As an example, the UE 110 may be an equipment mounted on a vehicle for driving. In some other embodiments, the UE 110 may be a device that performs machine type communication (MTC) operating without user involvement, or may be an autonomous vehicle. The UE may be referred to as electronic device, terminal, vehicle terminal, user equipment, mobile station, subscriber station, remote terminal, wireless terminal, user device, or by other terms with equivalent technical meaning. As a terminal, in addition to the UE, customer-premises equipment (CPE) or a dongle type terminal may be used. The customer-premises equipment, like a UE, may be connected to a NG-RAN node while providing the network to other communication equipments (e.g., laptops).

With reference to FIG. 1A, the access and mobility management function (AMF) 150 provides functions for access and mobility management in units of a UE 110, and one UE 110 may be connected by default to one AMF 150.

More specifically, the AMF 150 may perform at least one function among signaling between core network nodes for mobility between 3GPP access networks, interfacing (N2 interface) between radio access networks 120 (e.g., 5G RAN), NAS signaling with the UE 110, identification of the SMF 160, and delivery of session management (SM) messages between the UE 110 and the SMF 160. Some or all of the functions of the AMF 150 may be supported in a single instance of the AMF 150.

With reference to FIG. 1A, the session management function (SMF) 160 provides a session management function, and if the UE 110 has multiple sessions, the individual sessions may be managed by different SMFs 160.

More specifically, the SMF 160 may perform at least one function among session management (e.g., establishing, modifying, and releasing sessions, including maintaining tunnels between the UPF 170 and access network nodes), selection and control of user plane (UP) functions, traffic steering configuration for routing traffic to the appropriate destination in the UPF 170, termination at the SM portion of a NAS message, downlink data notification (DDN), and initiation of AN-specific SM information (e.g., delivery to the access network via the AMF 150 over the N2 interface). Some or all of the functions of the SMF 160 may be supported in a single instance of the SMF 160.

In the 3GPP system, conceptual links connecting NFs in the 5G system may be referred to as reference points. A reference point may also be referred to as an interface. Reference points (hereinafter used interchangeably with interfaces) included in the 5G system architecture expressed according to various embodiments of the disclosure are illustrated below:
N1: reference point between UE 110 and AMF 150;
N2: reference point between (R)AN 120 and AMF 150;
N3: reference point between (R)AN 120 and UPF 170;
N4: reference point between SMF 160 and UPF 170;
N5: reference point between PCF 180 and AF 130;
N6: reference point between UPF 170 and DN 140;
N7: reference point between SMF 160 and PCF 180;
N8: reference point between UDM 153 and AMF 150;
N9: reference point between two core UPFs 170;
N10: reference point between UDM 153 and SMF 160;
N11: reference point between AMF 150 and SMF 160;
N12: reference point between AMF 150 and authentication server function (AUSF) 151;
N13: reference point between UDM 153 and AUSF 151;
N14: reference point between two AMFs 150; and
N15: reference point between PCF 180 and AMF 150 for non-roaming scenario, reference point between PCF 180 and AMF 150 within visited network for roaming scenario

FIG. 1B illustrates a wireless environment including a core network in a wireless communication system according to an embodiment of the disclosure.

With reference to FIG. 1B, the wireless communication system may include a radio access network (RAN) 120 and a core network (CN).

The radio access network 120, as a network directly connected to a user device, for example, the UE 110, is an infrastructure that provides radio access to the UE 110.

The radio access network 120 may include a set of plural base stations including a base station 125, and the plural base stations may communicate through interfaces formed therebetween. At least some of the interfaces between the plural base stations may be wired or wireless.

The base station 125 may have a structure divided into a central unit (CU) and a distributed unit (DU). In this case, one CU may control multiple DUs.

The base station 125 may be referred to as base station, access point (AP), gNB (next generation node B), 5G node (5th generation node), wireless point, transmission/reception point (TRP), or by other terms with equivalent technical meaning. The UE 110 may connect to the radio access network 120 to communicate with the base station 125 through a radio channel. The UE 110 may be referred to as terminal, user equipment, mobile station, subscriber station, remote terminal, wireless terminal, user device, or by other terms with equivalent technical meaning.

The core network may be a network that manages the overall system, and may control the radio access network 120 and process data and control signals for the UE 110 transmitted and received through the radio access network 120. The core network may perform various functions such as controlling user plane and control plane, handling mobility, managing subscriber information, charging, and interworking with other types of systems (e.g., long term evolution (LTE) system). To perform the various functions described above, the core network may include a number of functionally separated entities with different network functions (NFs). For example, the core network 200 may include access and mobility management function (AMF) 150, session management function (SMF) 160, user plane function (UPF) 170, policy and charging function (PCF) 180, network repository function (NRF) 159, unified data management (UDM) 153, network exposure function (NEF) 155, and unified data repository (UDR) 157.

The user equipment (UE) 110 may be connected to the radio access network 120 to access the AMF 150, which performs a mobility management function of the core network.

The access and mobility management function (AMF) 150 is a function or equipment that is responsible for both access to the radio access network 120 and management of mobility of the UE 110.

The session management function (SMF) 160 is an NF that manages sessions. The AMF 150 may be connected to the SMF 160, and the AMF 150 may route session-related messages for the UE 110 to the SMF 160. The SMF 160 may connect to the UPF 170 to allocate user plane resources to be provided to the UE 110, and may establish a tunnel to transfer data between the base station 125 and the UPF 170.

The policy and charging function (PCF) 180 may control information related to the policy and charging for sessions used by the UE 110.

The network repository function (NRF) 159 may store information about NFs installed in a network of the mobile network operator and perform a function of notifying the stored information. The NRF 159 may be connected to all NFs. When an NF starts to operate on the operator network, the NF registers itself to the NRF 159 to notify the NRF 159 that the NF is operating on the network.

The unified data management (UDM) 153 is an NF that performs a similar role to the home subscriber server (HSS) of a 4G network, and may store subscription information of the UE 110 or context used by the UE 110 in the network.

The network exposure function (NEF) 155 may play a role in connecting 3rd party servers and NFs of the 5G mobile communication system. In addition, the NEF may provide data to the UDR 157, update data thereof, or obtain data therefrom.

The unified data repository (UDR) 157 may store subscription information of the UE 120, store policy information, store data exposed to the outside, or store information necessary for 3rd party applications. In addition, the UDR 157 may also provide stored data to other NFs.

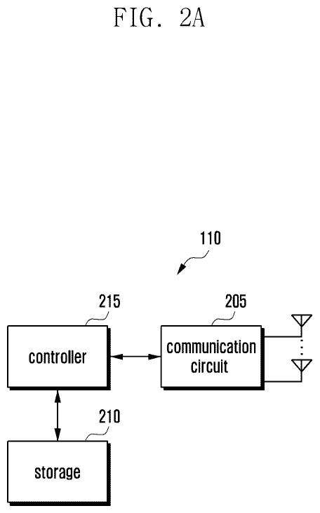

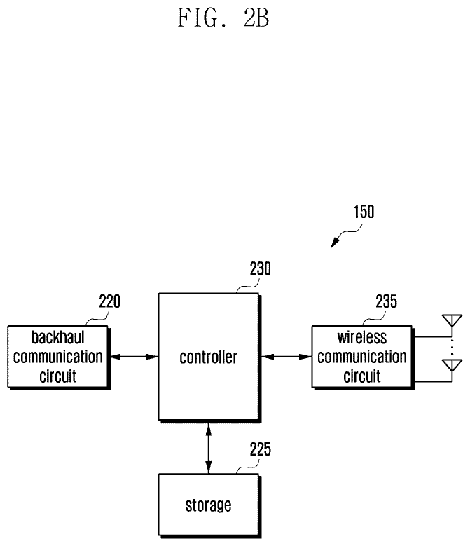

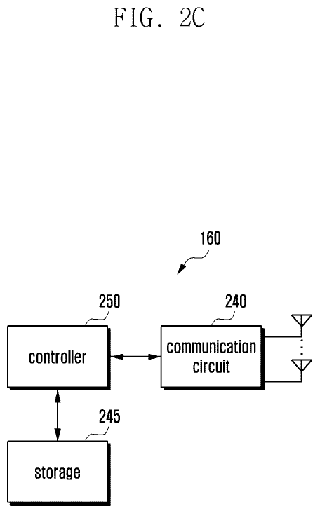

FIG. 2A illustrates a functional structure of a UE according to an embodiment of the disclosure.

The configuration illustrated in FIG. 2A may be understood as the configuration of the UE 110. In the following description, terms such as “ . . . unit“and” . . . module” refer to a unit that processes at least one function or operation, which may be implemented in hardware, software, or a combination thereof.

With reference to FIG. 2A, the UE may include a communication circuit 205, a storage 210, and a controller 215.

The communication circuit 205 may perform functions for transmitting and receiving signals through a radio channel. For example, the communication circuit 205 may perform a conversion function between a baseband signal and a bit stream according to the physical layer specification of the system. For example, during data transmission, the communication circuit 205 may generate complex symbols by encoding and modulating a transmission bit stream. In addition, during data reception, the communication circuit 205 may restore the reception bit stream by demodulating and decoding a baseband signal. In addition, the communication circuit 205 may up-convert a baseband signal into a radio frequency (RF) band signal and transmit the signal through an antenna, and may down-convert an RF band signal received through an antenna into a baseband signal. For example, the communication circuit 205 may include a transmission filter, a reception filter, an amplifier, a mixer, an oscillator, a digital to analog converter (DAC), an analog to digital converter (ADC), or the like.

In addition, the communication circuit 205 may include multiple transmission and reception paths. Further, the communication circuit 205 may include at least one antenna array composed of multiple antenna elements. In terms of hardware, the communication circuit 205 may be composed of digital circuits and analog circuits (e.g., radio frequency integrated circuit (RFIC)). Here, the digital circuits and analog circuits may be implemented in one package. Additionally, the communication circuit 205 may include multiple radio frequency (RF) chains. Further, the communication circuit 205 may perform beamforming.

The communication circuit 205 may transmit and receive signals as described above. Hence, all or part of the communication circuit 205 may be referred to as a transmitter, receiver, or transceiver. Additionally, in the following description, transmission and reception performed through a radio channel are used as including the meaning of the processing described above being performed by the communication circuit 205.

The storage 210 may store data such as basic programs, application programs, and configuration information for operation of the UE. The storage 210 may be composed of volatile memory, non-volatile memory, or a combination thereof. In addition, the storage 210 may provide stored data upon request from the controller 215.

The controller 215 may control the overall operations of the UE. For example, the controller 215 may transmit and receive signals through the communication circuit 205. Additionally, the controller 215 may write data to and read data from the storage 210. In addition, the controller 215 may perform functions of protocol stacks required by communication standards. To this end, the controller 215 may include at least one processor or microprocessor, or may be a part of a processor. Additionally, a portion of the communication circuit 205 and the controller 215 may be referred to as a communication processor (CP). According to various embodiments, the controller 215 may control synchronization using a wireless communication network. For example, the controller 215 may control the UE to perform operations according to various embodiments to be described later.

According to various embodiments of the disclosure, the UE may be composed of a mobile equipment (ME) and a universal mobile telecommunications service (UMTS) subscriber identity module (USIM). The ME may include a mobile terminal (MT) and terminal equipment (TE). The MT may be the part where the radio access protocol operates, and the TE may be the part where the control function operates. For example, in the case of a wireless communication terminal (e.g., mobile phone), the MT and TE may be integrated; and in the case of a laptop, the MT and TE may be separated. Various embodiments of the disclosure may be described in various manners by representing the ME and USIM as distinct entities, representing the ME and USIM as a terminal (e.g., UE), or representing the ME as a terminal, according to the operation of individual configurations.

FIG. 2B illustrates a functional structure of a base station according to an embodiment of the disclosure.

The configuration illustrated in FIG. 2B may be understood as the configuration of the base station 120. In the following description, terms such as “ . . . unit“and” . . . module” refer to a unit that processes at least one function or operation, which may be implemented in hardware, software, or a combination thereof.

With reference to FIG. 2B, the base station may include a wireless communication circuit 235, a backhaul communication circuit 220, a storage 225, and a controller 230.

The wireless communication circuit 235 may perform functions for transmitting and receiving signals through a radio channel. For example, the wireless communication circuit 235 may perform a conversion function between a baseband signal and a bit stream according to the physical layer specification of the system. For example, during data transmission, the wireless communication circuit 235 may generate complex symbols by encoding and modulating a transmission bit stream. In addition, during data reception, the wireless communication circuit 235 may restore the reception bit stream by demodulating and decoding a baseband signal.

In addition, the wireless communication circuit 235 may up-convert a baseband signal into a radio frequency (RF) band signal and transmit the signal through an antenna, and may down-convert an RF band signal received through an antenna into a baseband signal. To this end, the wireless communication circuit 235 may include a transmission filter, a reception filter, an amplifier, a mixer, an oscillator, a digital to analog converter (DAC), an analog to digital converter (ADC), or the like. In addition, the wireless communication circuit 235 may include multiple transmission and reception paths. Further, the wireless communication circuit 235 may include at least one antenna array composed of multiple antenna elements.

In terms of hardware, the wireless communication circuit 235 may be composed of a digital unit and an analog unit, where the analog unit may be composed of multiple sub-units depending on the operating power, operating frequency, or the like. The digital unit may be implemented with at least one processor (e.g., digital signal processor (DSP)).

The wireless communication circuit 235 may transmit and receive signals as described above. Hence, all or part of the wireless communication circuit 235 may be referred to as a transmitter, receiver, or transceiver. Additionally, in the following description, transmission and reception performed through a radio channel are used as including the meaning of the processing described above being performed by the wireless communication circuit 235.

The backhaul communication circuit 220 may provide an interface for communicating with other nodes in the network. That is, the backhaul communication circuit 220 may convert a bit stream to be transmitted from the base station to another node, for example, another access node, another base station, upstream node, or core network into a physical signal, and may convert a physical signal received from another node into a bit stream.

The storage 225 may store data such as basic programs, application programs, and configuration information for operation of the base station. The storage 225 may be composed of volatile memory, non-volatile memory, or a combination thereof. In addition, the storage 225 may provide stored data upon request from the controller 230.

The controller 230 may control the overall operations of the base station. For example, the controller 230 may transmit and receive signals through the wireless communication circuit 235 or the backhaul communication circuit 220. Additionally, the controller 230 may write data to and read data from the storage 225. In addition, the controller 230 may perform functions of protocol stacks required by communication standards. According to another implementation example, the protocol stacks may be included in the wireless communication circuit 235. To this end, the controller 230 may include at least one processor. According to various embodiments, the controller 230 may control synchronization using a wireless communication network. For example, the controller 230 may control the base station to perform operations according to various embodiments to be described later.

FIG. 2C illustrates a functional structure of a core network entity according to an embodiment of the disclosure.

The configuration of a core network entity in a wireless communication system according to various embodiments of the disclosure is shown. The configuration illustrated in FIG. 2C may be understood as the configuration of an entity having at least one function among the network entities including the AMF 150 shown in FIG. 1. In the following description, terms such as “ . . . unit“and” . . . module” refer to a unit that processes at least one function or operation, which may be implemented in hardware, software, or a combination thereof.

With reference to FIG. 2C, the core network entity includes a communication circuit 240, a storage 245, and a controller 250.

The communication circuit 240 may provide an interface for communicating with other entities in the network. That is, the communication circuit 240 may convert a bit stream to be transmitted from the core network entity to another entity into a physical signal, and may convert a physical signal received from another entity into a bit stream. That is, the communication circuit 240 may transmit and receive signals. Hence, the communication circuit 240 may be referred to as a modem, a transmitter, a receiver, or a transceiver. At this time, the communication circuit 240 may enable the core network entity to communicate with other entities or systems through a backhaul connection (e.g., wired backhaul or wireless backhaul) or through a network.

The storage 245 may store data such as basic programs, application programs, and configuration information for operation of the core network entity. The storage 245 may be composed of volatile memory, non-volatile memory, or a combination thereof. In addition, the storage 245 may provide stored data upon request from the controller 250.

The controller 250 may control the overall operations of the core network entity. For example, the controller 250 may transmit and receive signals through the communication circuit 240. Additionally, the controller 250 may write data to and read data from the storage 245. To this end, the controller 250 may include at least one processor. According to various embodiments, the controller 250 may control synchronization using a wireless communication network. For example, the controller 250 may control the core network entity to perform operations according to various embodiments to be described later.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

For convenience of description below, the disclosure may use terms and names defined in the 5G system (5GS) and new radio (NR) standards, which are the most recent standards defined by the 3GPP organization among currently existing communication standards. However, the disclosure is not limited by the above terms and names, and may be equally applied to wireless communication networks complying with other standards. In particular, the disclosure may be applied to 3GPP 5^{th} generation mobile communication standards (e.g., 5GS and NR).

The UE may have dual connectivity. In dual connectivity, the base station that provides macro cell coverage may become a master node (MN) and handle both the control plane and the user plane, and the other base station with small cell coverage may be referred to as a secondary node (SN) and play an auxiliary role of handling some user plane or some control plane. That is, the MN may process control signaling, and the SN may be used to improve data transmission speed.

The MN may provide conditional PSCell change (CPC) configuration information to the UE; the UE may evaluate the corresponding condition, and if the condition is satisfied, the UE may make a change request to the SN that meets the condition. In addition, the UE may store CPC configuration information for several SNs provided by the MN and may make an SN change request whenever the condition is satisfied after evaluation. At this time, the UE may change the key the UE uses whenever the UE changes the SN, and even if changed to the same SN, the UE may not use a previously used key. To this end, the MN provides the UE with multiple SN counter values for each SN.

Hereinafter, the disclosure will provide a method for performing security key synchronization when making repeated SN changes in a dual connectivity situation of the UE.

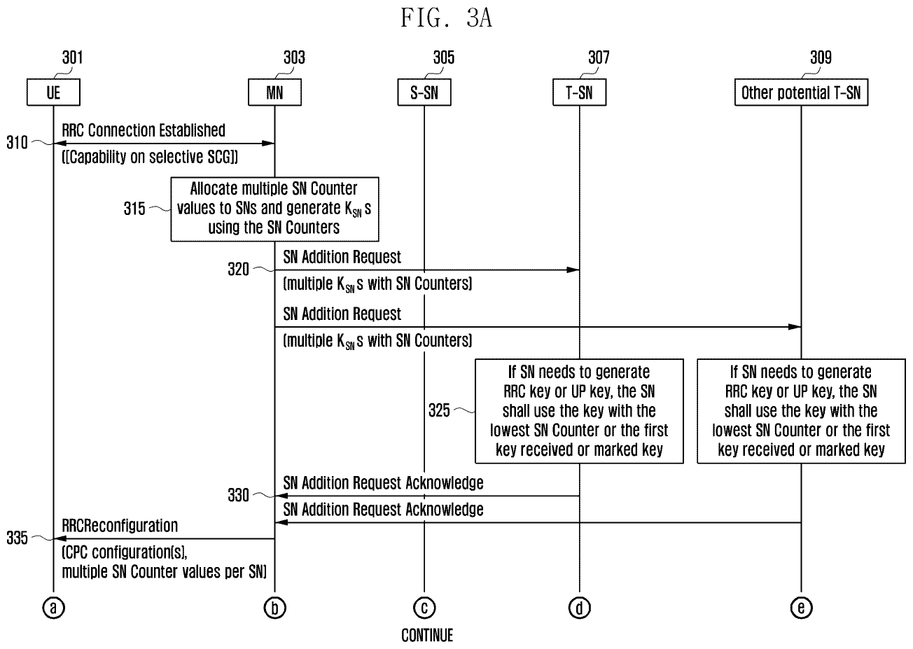

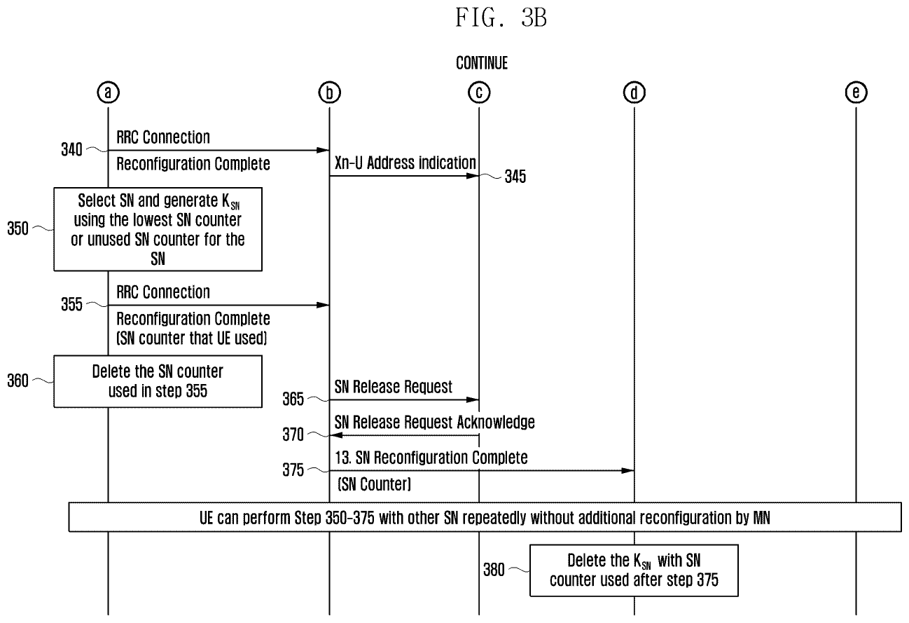

FIGS. 3A and 3B illustrate processes for performing security key synchronization according to an embodiment of the disclosure.

More specifically, FIG. 3 illustrates a process of synchronizing the K_{SN} to be used in the UE and the secondary node (SN) when making repeated conditional SN changes in a dual connectivity situation according to an embodiment of the disclosure.

With reference to FIGS. 3A and 3B, at step 310, the user equipment (UE) 301 and the master node (MN) 303 may share their respective capabilities or capability information for repeated conditional SN changes (selective SCG) with each other. The capabilities or capability information for repeated conditional SN changes may include an indication indicating whether selective SCG is supported.

Sharing of the capabilities or capability information for repeated conditional SN changes may be performed through registration messages or access stratum (AS) SMC messages. The SMC messages may include an AS security mode command message transmitted from the base station to the UE, and an AS security mode complete message transmitted from the UE to the base station in response.

The AS security mode command message is a message transmitted from the base station to the UE and may be a first integrity-protected message among AS messages.

The AS security mode complete message is a message transmitted from the UE to the base station and may be a first encrypted and integrity protected message among AS messages.

If the UE 301 or the MN 303 does not transmit their capabilities or capability information for repeated conditional SN changes, this may itself imply that the UE or MN does not support selective SCG.

The UE may know whether selective SCG is supported by the base station depending upon transmission of multiple SN counter values at step 335.

Selective SCG may refer to a technology in which the UE receives SN RRC conditional configuration information for one or more SNs from the MN and makes repeated SN changes based on the received information without receiving additional information from the MN.

More specifically, this may refer to a process in which when the MN makes a resource allocation request for a PDU (protocol data unit) session or QoS (quality of service) flow of the UE to one or more SNs, and the MN transmits an RRC reconfiguration message including SN RRC conditional configuration information for each SN, the UE uses the received conditional information to make a change request repeatedly for the SN that meets a specific condition in a situation where the condition is satisfied.

In other words, this may mean that if the MN has transmitted an indication that the MN supports selective SCG, the UE having received SN RRC conditional configuration information for multiple SNs may make an SN change request to the MN whenever the condition is met without receiving additional configuration information from the MN.

This may mean that if the UE has transmitted an indication that the UE supports selective SCG, the UE may make an SN change repeatedly after receiving SN RRC conditional configuration information for multiple SNs.

At step 315, the MN 303 may allocate one or more SN counter values for each of the least one SN and generate a K_{SN} key by using one SN counter value allocated to each SN.

More specifically, if the MN 303 has determined to perform selective SCG, the MN may allocate multiple SN counter values to each of the SNs for which resource allocation is to be requested. After allocating multiple SN counter values to each SN, the MN 303 may generate multiple K_{SN} keys by using the SN counter values.

The MN 303 may know in advance whether the SN supports selective SCG before allocating SN counter values to the SNs. To generate K_{SN}, the MN 303 may use K_{SN}, 0x79, SN counter value, SN counter length, or the like as input values. Additionally, the MN may use the SN counter to generate a key ID representing each K_{SN}. For example, the method for the MN to generate a key ID using an SN counter may include utilizing at least one of K_{MN}, K_{SN}, a value similar to 0x79, a UE ID known to the MN, or an SN counter.

K_{SN} is a key used by the secondary node (SN), and the SN may use K_{SN} to generate a key used for encryption and integrity protection of user plane (UP) data exchanged between the UE and the SN.

At step 320, the MN 303 may transmit an SN addition request message to at least one SN. The at least one SN may include a target SN (T-SN) 307 and/or other potential T-SN 309 shown in FIG. 3.

More specifically, the MN 303 may make a resource allocation request for one or more PDU (protocol data unit) sessions or QoS (quality of service) flows to the SN by using the SN addition request message.

The MN 303 may transmit an SN addition request message including one or more K_{SN} keys together with at least one of the SN counter value(s) used to generate these keys, key ID(s) identifying these keys, UP security capabilities (lists of encryption algorithms and integrity protection algorithms supported by the UE), or UP security policies (factors indicating whether to perform UP data encryption and integrity protection and may have one of the values “required,” “preferred,” and “not needed” for each of encryption and integrity protection). When transmitting multiple K_{SN} keys to each SN, the MN 303 may place a mark on one of the multiple keys allocated to each SN.

To enable the UE to perform repeated conditional SN changes, the process in which the MN makes a resource allocation request to the SN through the SN addition request message may be not limited to making a resource allocation request to one SN. For example, the MN may make a resource allocation request to multiple SNs. The MN may request whether the SN has a capability for selective SCG.

The MN 303 may separately store SN counter values allocated to individual SNs. That is, the MN 303 may store SN counter value(s) allocated to each SN in a manner associated with the SN. In the future, in case of newly allocating SN counter value(s) to the UE or secondary node key update, the MN 303 may maintain the largest value among the allocated SN counter value(s). Alternatively, the MN 303 may maintain the value obtained by adding 1 to the largest value among the allocated SN counter value(s).

At step 325, the at least one SN may generate a radio resource control (RRC) key or a user plane (UP) key.

More specifically, if the SN(s) (which may include T-SN 307 and/or other potential T-SN 309) need to generate RRC keys or UP keys, each SN may select a K_{SN} key according to an agreed upon rule, such as K_{SN} corresponding to the smallest SN counter value, K_{SN} separately marked by the MN, or K_{SN} received first, and generate the RRC key and UP key by using the selected key.

At step 330, the at least one SN may transmit an SN addition request acknowledge message to the MN 303.

More specifically, if the SN (which may include T-SN 307 and/or other potential T-SN 309) can accept the resource allocation request of the MN 303 for step 325, the SN may transmit an SN addition request acknowledge message in response to step 320.

The SN addition request acknowledge message may further include at least one indication for the algorithm selected by the SN, whether UP data is integrity protected, and whether UP data is encrypted.

In addition, the SN addition request acknowledge message may include an SN RRC configuration message including a radio resource configuration.

If the MN 303 requests a capability for selective SCG at step 320, the SN may respond if the SN has the capability. For example, the SN may respond through a selective SCG capability indication. If the SN does not respond to the capability for selective SCG, this may indicate that the SN does not support selective SCG.

At step 335, the MN 303 may transmit an RRC reconfiguration message to the UE 301.

More specifically, the MN 303 may transmit, to the UE, an RRC reconfiguration message (e.g., RRC connection reconfiguration message or RRCReconfiguration message) that may include the SN RRC configuration(s) message received from the SN(s) at step 330.

The RRC reconfiguration message (e.g., RRC connection reconfiguration message or RRCReconfiguration message) may include conditional PSCell change (CPC) configuration information (list of RRC connection reconfiguration messages transmitted by SNs).

Additionally, the RRC reconfiguration message (e.g., RRC connection reconfiguration message or RRCReconfiguration message) may include the following information per SN: at least one of SN counter value(s), algorithm selected by the SN, indication whether UP data is encrypted, or indication whether UP data is integrity protected.

If the MN 303 has transmitted multiple keys including a marked one to each SN at step 320, the MN may also mark the SN counter value(s) used to generate the corresponding key and transmit the key to the UE 301. When transmitting one SN counter corresponding to one SN, this may be a case where the SN does not support selective SCG. The MN may separately store only the largest value among the SN counter values having been transmitted, or may separately store the result obtained by adding 1 to the largest value. Alternatively, the MN may store all of the SN counter values having been transmitted, or may store only the largest values among the values having been allocated to individual SNs. This may be information used to update the K_{SN} key or to use the corresponding function additionally in the future.

At step 340, the UE 301 may apply the RRC reconfiguration message (e.g., RRC connection reconfiguration message or RRCReconfiguration message) transmitted by the MN 303, and may store the CPC configuration information and SN counter value(s) for each SN transmitted by the MN 303 at step 335.

At step 345, the MN 303 may notify the source SN 303 that CPC information has been configured to the UE, through an Xn-U Address Indication process.

At step 350, the UE 301 may start to evaluate the execution conditions based on the CPC configuration information received from the MN 303 at step 335. If the execution condition associated with a candidate SN is met, the UE 301 may prepare to connect to the SN that meets its execution condition.

Among multiple SN counter value(s) for the corresponding SN received from the MN 303 at step 335, the UE 301 may select an unused SN counter value, the smallest SN counter value, or the separately marked SN counter value, and may generate a K_{SN} key by using the SN counter value, K_{MN}, 0x79, SN counter length, or the like as input.

At step 355, the UE 301 may transmit an RRC reconfiguration complete message to the MN 303 to notify the selected SN.

More specifically, the UE 301 may transmit an RRC reconfiguration complete message (e.g., RRC connection reconfiguration complete message or RRCReconfiguration complete message) notifying the MN of the SN selected after evaluating the execution conditions based on the CPC configuration information received from the MN 303 at step 335.

The RRC reconfiguration complete message may include the SN counter value used by the UE to generate K_{SN}, the order of the used SN counter value among the multiple SN counter values received for the corresponding SN, or the key ID generated in the same way as the MN by using the used SN counter.

If the SN counter value transmitted by the UE 301 is the last remaining value or last unused value among the SN counter value(s) that the UE 301 has received from the MN 303 for the corresponding SN, the UE 301 may transmit an indication that all SN Counters have been used for the corresponding SN. This indication may be transmitted by being included in the RRC reconfiguration complete message.

If the MN 303 stores all the SN Counters allocated to each SN, the MN 303 may determine whether the SN counter value transmitted by the UE 301 matches (or is the same as) the value allocated by the MN 303 to the corresponding SN and may identify whether it is necessary to allocate new SN counter value(s) to the UE 301 for the corresponding SN. Thereafter, the MN 303 may allocate new SN counter value(s) and deliver the same to the UE 301, if necessary.

At step 360, the UE 301 may delete the SN counter value corresponding to the value transmitted at step 355 after performing step 355, or may place a mark on the corresponding SN counter value to indicate that the value has been used.

In the drawing, step 360 is indicated as being performed immediately after step 355, but the scope of the disclosure is not limited thereto, and step 360 may be performed at any time after step 355.

At step 365, the MN 303 may transmit an SN release request message to the source SN (S-SN) 305.

At step 370, the S-SN may transmit an SN release request acknowledge message to the MN 303.

At step 375, the MN 303 may add the value received from the UE 301 at step 355 or the key ID generated using the received SN counter to an SN reconfiguration complete message and transmit the message to the SN.

The SN having received this may find the K_{SN} key based on the received value, and then the SN may use the found K_{SN} for communication with the UE.

The MN 303 may compare the SN counter value received from the UE 301 at step 355 with the SN counter value maintained by the MN 303.

For example, if the SN counter value transmitted by the UE 301 is less than the value maintained by the MN 303, the MN 303 may keep the maintained SN counter value as is.

On the other hand, if the SN counter value transmitted by the UE 301 is greater than or equal to the value maintained by the MN 303, the MN 303 may transmit an error message to the UE 301.

When the MN 303 generates a K_{SN} key by using the SN counter value, if the SN counter value used is less than the SN counter value maintained by the MN 303, the MN 303 may keep the maintained SN counter as is (SN counter maintenance).

When the MN 303 generates a K_{SN} key by using the SN counter value, if the SN counter value used is equal to the SN counter value maintained by the MN 303, after generating the key or transmitting the used SN counter to the UE 301, the MN 403 may increment the maintained SN counter by 1 and maintain the counter (secondary node key update).

Additionally, if there is a change in the K_{gNB} (i.e., K_{MN}) key in the MN 303, for selective SCG activation, the MN 303 may reset the SN Counters (e.g., to 0), allocate new SN counter value(s) to each SN, and transmit the same to the UE 301. If there is a change in K_{gNB} (i.e., K_{MN}), the UE 301 may delete the SN counter value received for selective SCG activation even if the value is an unused SN counter value and wait to receive an SN counter value again from the MN 303.

Although if there is an unused K_{SN}, if new K_{SN}(s), SN counter(s), or key ID(s) are received from the MN 303 through an SN addition request, the SN may delete the previously stored value(s) (e.g., K_{SN}, SN counter(s), or key ID(s)).

Steps 350 to 375 may occur repeatedly without additional execution of steps 310 to 340.

At step 380, if the UE selects and connects to one of the other potential T-SNs 309, the selected T-SN 307 may delete the K_{SN} and its value corresponding to the value received at step 375 among the K_{SN} keys received at step 320.

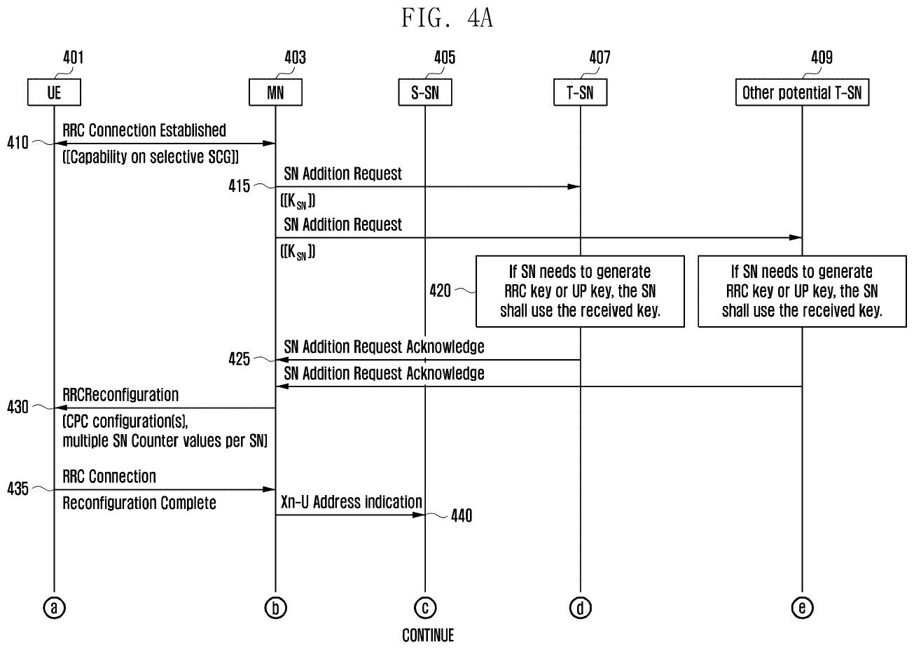

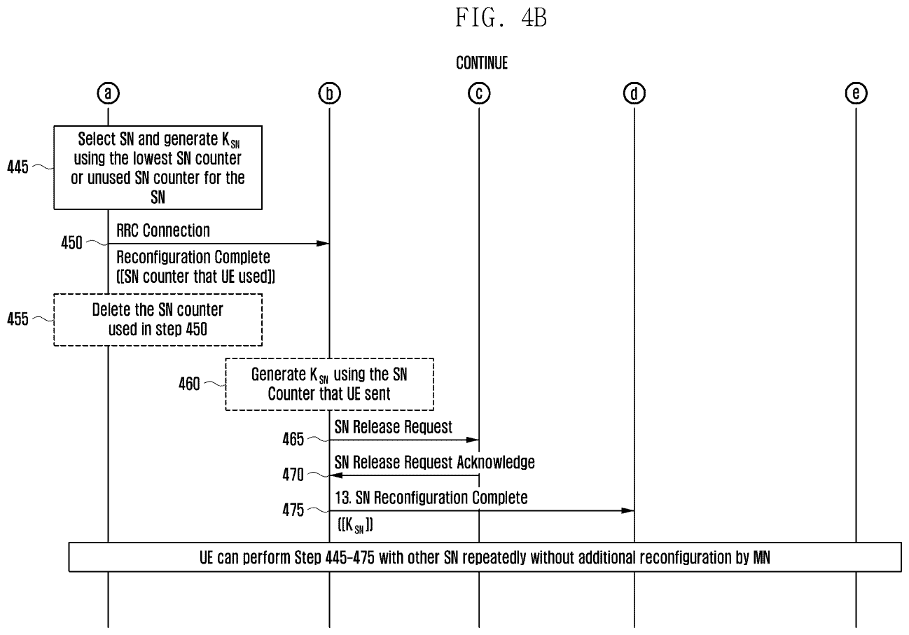

FIGS. 4A and 4B illustrate processes for performing security key synchronization according to another embodiment of the disclosure.

More specifically, FIGS. 4A and 4B are a sequence diagram illustrating a process of synchronizing the K_{SN} to be used in the UE and the secondary node (SN) when making repeated conditional SN changes in a dual connectivity situation according to an embodiment of the disclosure.

With reference to FIGS. 4A and 4B, at step 410, the user equipment (UE) 401 and the master node (MN) 403 may share their respective capabilities or capability information for repeated conditional SN changes (selective SCG) with each other. The capabilities or capability information for repeated conditional SN changes may include an indication indicating whether selective SCG is supported.

Sharing of the capabilities or capability information for repeated conditional SN changes may be performed through registration messages or access stratum (AS) SMC messages. As described above, the SMC messages may include an AS security mode command message transmitted from the base station to the UE, and an AS security mode complete message transmitted from the UE to the base station.

The AS security mode command message is a message transmitted from the base station to the UE and may be a first integrity-protected message among AS messages.

The AS security mode complete message is a message transmitted from the UE to the base station and may be a first encrypted and integrity protected message among AS messages.

If the UE 401 or the MN 403 does not transmit their capabilities or capability information for repeated conditional SN changes, this may itself imply that the UE or MN does not support selective SCG.

The UE may know whether selective SCG is supported by the base station depending upon transmission of multiple SN counter values at step 435.

Selective SCG may refer to a technology in which the UE receives SN RRC conditional configuration information for one or more SNs from the MN and makes an SN change repeatedly based on the received information without receiving additional information from the MN.

More specifically, this may refer to a process in which when the MN makes a resource allocation request for a PDU (protocol data unit) session or QoS (quality of service) flow of the UE to one or more SNs, and the MN transmits an RRC reconfiguration message including SN RRC conditional configuration information for each SN, the UE uses the received conditional information to repeatedly make a change request for the SN that meets a specific condition in a situation where the condition is satisfied.

In other words, this may mean that if the MN has transmitted an indication that the MN supports selective SCG, the UE having received SN RRC conditional configuration information for multiple SNs may make an SN change request to the MN whenever the conditions are met without receiving additional configuration information from the MN.

This may mean that if the UE has transmitted an indication that the UE supports selective SCG, the UE may make an SN change repeatedly after receiving SN RRC conditional configuration information for multiple SNs.

At step 415, the MN 403 may transmit an SN addition request message to at least one SN. The at least one SN may include a target SN (T-SN) 407 and/or other potential T-SN 409 shown in FIG. 3.

More specifically, if the MN 401 has determined to perform selective SCG, the MN may transmit an SN addition request to SNs for which resource allocation is to be requested. The MN may make a resource allocation request for one or more PDU sessions or QoS flows to the SN by using an SN addition request message.

The MN 403 may know in advance whether the SN supports selective SCG. The MN may transmit one K_{SN} to the SN via an SN addition request message; to generate a K_{SN}, the MN may use K_{SN}, 0x79, SN counter value, SN counter length, or the like as input values. The MN may generate keys by allocating different SN counter values to individual SNs. The MN may not transmit a K_{SN} via an SN addition request.

K_{SN} is a key used by the secondary node (SN), and the SN may use K_{SN} to generate a key used for encryption and integrity protection of user plane (UP) data exchanged between the UE and the SN.

The MN 403 may transmit an SN addition request message including one K_{SN}key together with at least one of the SN counter value(s) or key ID(s) used to generate the key, UP security capabilities (lists of encryption algorithms and integrity protection algorithms supported by the UE), or UP security policies (factors indicating whether to perform UP data encryption and integrity protection and may have one of the values “required,” “preferred,” and “not needed” for each of encryption and integrity protection).

To enable the UE to perform repeated conditional SN changes, the process in which the MN makes a resource allocation request to the SN through the SN addition request message may be not limited to making a resource allocation request to one SN. For example, the MN may make a resource allocation request to multiple SNs. The MN may request whether the SN has a capability for selective SCG.

More specifically, if the MN 403 has determined to perform selective SCG, the MN may allocate multiple SN counter values to each of the SNs for which resource allocation is to be requested. The MN 403 may separately store SN counter values allocated to individual SNs. That is, the MN 403 may store SN counter value(s) allocated to each SN in a manner associated with the SN. In the future, in case of newly allocating SN counter value(s) to the UE or secondary node key update, the MN 403 may maintain the largest value among the allocated SN counter value(s). Alternatively, the MN 303 may maintain the value obtained by adding 1 to the largest value among the allocated SN counter value(s).

At step 420, the at least one SN may generate a radio resource control (RRC) key or a user plane (UP) key.

More specifically, if the SN(s) (which may include T-SN 407 and/or other potential T-SN 409) need to generate RRC keys or UP keys, each SN may generate them by using the received K_{SN}. If the key is not received at step 415, the SN may be unable to generate the RRC key or UP key.

At step 425, the at least one SN may transmit an SN addition request acknowledge message to the MN 403.

More specifically, if the SN (which may include T-SN 407 and/or other potential T-SN 409) can accept the resource allocation request of the MN 403 for step 415, the SN may transmit an SN addition request acknowledge message in response to step 415.

The SN addition request acknowledge message may further include at least one indication for the algorithm selected by the SN, whether UP data is integrity protected, and whether UP data is encrypted.

In addition, the SN addition request acknowledge message may include an SN RRC configuration message including a radio resource configuration.

If the MN 403 requests a capability for selective SCG at step 415, the SN may respond if the SN has the capability. For example, the SN may respond through a selective SCG capability indication. If the SN does not respond to the capability for selective SCG, this may indicate that the SN does not support selective SCG.

At step 430, the MN 403 may transmit an RRC reconfiguration message to the UE 401.

More specifically, the MN 403 may transmit, to the UE, an RRC reconfiguration message (e.g., RRC connection reconfiguration message or RRCReconfiguration message) that may include the SN RRC configuration(s) message received from the SN(s) at step 425.

The RRC reconfiguration message (e.g., RRC connection reconfiguration message or RRCReconfiguration message) may include conditional PSCell change (CPC) configuration information (list of RRC connection reconfiguration messages transmitted by SNs).

Additionally, the RRC reconfiguration message (e.g., RRC connection reconfiguration message or RRCReconfiguration message) may include the following information per SN: at least one of SN counter value(s), algorithm selected by the SN, indication whether UP data is encrypted, or indication whether UP data is integrity protected.

The NIN 403 may place a mark on one of the SN counter values corresponding to each SN and transmit it, which may be the SN counter value used to generate the key transmitted at step 415. Alternatively, if there is no separate mark, the UE may use the smallest SN counter value first. When transmitting one SN counter corresponding to one SN, this may be a case where the SN does not support selective SCG. The MN may separately store only the largest value among the SN counter values having been transmitted, may separately store the result obtained by adding 1 to the largest value, or may store all of the SN counter values having been transmitted. This may be information used to update the K_{SN} key in the future. If the UE 401 needs to generate an RRC key or UP key, the UE may use the smallest value among the SN counter value(s) corresponding to the SN (which may include T-SN 407 and/or other potential T-SN 409), the value with a mark received from the MN, or a value determined by a separately agreed upon rule.

At step 435, the UE 401 may apply the RRC reconfiguration message (e.g., RRC connection reconfiguration message or RRCReconfiguration message) transmitted by the MN 403, and may store the CPC configuration information and SN counter value(s) for each SN transmitted by the MN 403 at step 430.

At step 440, the MN 403 may notify the source SN that CPC information has been configured to the UE, through an Xn-U Address Indication process.

At step 445, the UE may start to evaluate the execution conditions based on the CPC configuration information received from the MN at step 430. If the execution condition associated with a candidate SN is met, the UE 401 may prepare to connect to the SN that meets its execution condition.

Among multiple SN counter value(s) for the corresponding SN received from the MN at step 430, the UE 401 may select an unused SN counter value, the smallest SN counter value, or the separately marked SN counter value, and may generate a K_{SN} key by using the SN counter value, K_{MN}, 0x79, SN counter length, or the like as input.

At step 450, the UE 401 may transmit an RRC reconfiguration complete message (e.g., RRC connection reconfiguration complete message or RRCReconfiguration complete message) notifying the MN of the SN selected after evaluating the execution conditions based on the CPC configuration information received from the MN 403 at step 430. This message may include the SN counter value used by the UE to generate K_{SN}.

If the SN counter value transmitted by the UE 401 is the last remaining value or last unused value among the SN counter value(s) that the UE 401 has received from the MN 403 for the corresponding SN, the UE 401 may transmit an indication that all SN Counters have been used for the corresponding SN. This indication may be transmitted by being included in the RRC reconfiguration complete message.

At step 455, the UE 401 may delete the SN counter value corresponding to the value transmitted at step 450 after performing step 450, or may place a mark on the corresponding SN counter value to indicate that the value has been used.

In the drawing, step 455 is indicated as being performed immediately after step 450, but the scope of the disclosure is not limited thereto, and step 455 may be performed at any time after step 450.

At step 460, the MN 403 may generate the same K_{SN} key by using the SN counter value transmitted by the UE at step 450.

Although step 460 is indicated as is in the drawing, the scope of the disclosure is not limited thereto, and step 460 may be performed at any time before step 475. If the SN counter value received from the UE is a value corresponding to the key transmitted to the corresponding SN at step 415, or if the SN counter value has not been received from the UE, an additional key may be not generated.

The MN 403 may compare the SN counter value received from the UE 401 at step 450 with the SN counter value maintained by the MN 403.

For example, if the SN counter value transmitted by the UE 401 is less than the value maintained by the MN 403, the MN 403 may keep the maintained SN counter value as is.

On the other hand, if the SN counter value transmitted by the UE 401 is greater than or equal to the value maintained by the MN 403, the MN 403 may transmit an error message to the UE 401.

Alternatively, if the MN 403 stores all the SN Counters allocated to each SN, the MN 403 may determine whether the SN counter value transmitted by the UE 401 matches (or is the same as) the value allocated by the MN 403 to the corresponding SN and may identify whether it is necessary to allocate new SN counter value(s) to the UE 401 for the corresponding SN. Thereafter, the MN 403 may allocate new SN counter value(s) and deliver the same to the UE 401, if necessary.

At step 465, the MN 403 may transmit an SN release request message to the source SN (S-SN) 405.

At step 470, the S-SN 405 may transmit an SN release request acknowledge message to the MN.

At step 475, the MN 403 may transmit an SN reconfiguration complete message to the T-SN 407. The MN 403 may add (or include) the K_{SN} generated at step 460 to the SN reconfiguration complete message. Although the T-SN 407 has received the K_{SN} corresponding to the UE 401 at step 415, if T-SN 407 receives the same key or different key at step 475, TOSN 407 may use the most recently received key. In such a case, the T-SN 407 may not use the key received at step 415 or may delete it.

Steps 445 to 475 may occur repeatedly without additional execution of steps 410 to 440.

When the MN 403 generates a K_{SN} key by using the SN counter value, if the SN counter value used is less than the SN counter value maintained by the MN 403, the MN 403 may keep the maintained SN counter as is (SN counter maintenance).

When the MN 403 generates a K_{SN} key by using the SN counter value, if the SN counter value used is equal to the SN counter value maintained by the MN 403, after generating the key or transmitting the used SN counter to the UE 401, the MN 403 may increment the maintained SN counter by 1 and maintain the counter (secondary node key update).

Additionally, if there is a change in the K_{gNB} (i.e., K_{MN}) key in the MN 403, for selective SCG activation, the MN 403 may reset the SN Counters (e.g., to 0), allocate new SN counter value(s) to each SN, and transmit the same to the UE 401. If there is a change in K_{gNB} (i.e., K_{MN}), the UE 401 may delete the SN counter value received for selective SCG activation even if the counter value is an unused SN counter value and wait to receive an SN counter value again from the MN 403.

It should be noted that the block diagrams, schematic diagrams of control/data signal transmission and reception methods, and schematic operational procedure diagrams shown in FIGS. 1A to 4B are not intended to limit the scope of the embodiments of the disclosure. That is, any component, entity, or operational step depicted in FIGS. 1A to 4B should not be construed as an essential element for carrying out the disclosure, and the disclosure may be implemented with only some components within a range that does not impair the subject matter.

The above-described operations of the embodiments may be realized by providing a memory storing the corresponding program codes in a specific component of the equipment. That is, the controller of the equipment may perform the above-described operations by causing a processor or CPU (central processing unit) to read and execute the program codes stored in the memory.

The various components and modules of the entity or terminal described herein may be realized or operated by using hardware (e.g., complementary-metal-oxide-semiconductor based logic circuit), firmware, software, or software embedded in a machine readable medium, or any combination thereof. For example, various electrical structures and methods may be realized by using electrical circuits such as transistors, logic gates, or application specific integrated circuits.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide area network (WAN), or a storage area network (SAN), or through a communication network composed of a combination thereof. Such a storage device may access the equipment that carries out an embodiment of the disclosure through an external port. In addition, a separate storage device on a communication network may access the equipment that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, specific embodiments have been described in the detailed description of the disclosure, but various modifications are possible without departing from the scope of the disclosure. Therefore, the scope of the disclosure should not be limited to those embodiments described above, but should be determined according to the patent claims described later and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a master node (MN) in a communication system, the method comprising:
transmitting, to at least one target secondary node (SN), an SN addition request message including at least one SN counter value and K_{SN} key corresponding to each target SN, wherein each target SN includes a first target SN and a second target SN;
transmitting, to a user equipment (UE), a first radio resource control (RRC) reconfiguration message including the at least one SN counter value and the K_{SN} key corresponding to each target SN; and
transmitting, to the first target SN, an SN reconfiguration complete message including an SN counter value received from the UE.

2. The method of claim 1, further comprising:
receiving, from the at least one target SN, an SN addition request acknowledge message including at least one algorithm information or user plane (UP) integrity and encryption information; and
receiving, from the UE, an RRC reconfiguration complete message including the SN counter value,
wherein the SN counter value is used for deriving the K_{SN} key.

3. The method of claim 1, further comprising:
in case that a new key is established, deriving a new SN counter value for each target SN; and
transmitting, to the UE, a second RRC reconfiguration message including the new SN counter value for each target SN.

4. The method of claim 1, wherein the MN maintains a largest SN counter value among the at least one SN counter value each of which corresponds to each target SN.

5. A method performed by a first target secondary node (SN) in a communication system, the method comprising:
receiving, from a master node (MN), an SN addition request message including at least one SN counter value and K_{SN} key corresponding to each target SN, wherein each target SN includes the first target SN and a second target SN;
transmitting, to the MN, a SN addition request acknowledge message including at least one algorithm information, or user plane (UP) integrity and encryption information; and
receiving, from the MN, an SN reconfiguration complete message including an SN counter value received from a user equipment (UE).

6. The method of claim 5, further comprising:
receiving, from the MN, at least one second K_{SN} key and second SN counter value corresponding to the first target SN;
deleting at least one stored SN counter value and the K_{SN} key; and
storing the at least one second K_{SN} key and the second SN counter value.

7. The method of claim 5, wherein the SN counter value received from the UE is used for a communication between the UE and the first target SN.

8. The method of claim 5, further comprising:
computing UP keys based on a smallest SN counter value among the at least one SN counter value.

9. A method performed by a user equipment (UE) in a communication system, the method comprising:
receiving, from a master node (MN), a first radio resource control (RRC) reconfiguration message including at least one secondary node (SN) counter value and K_{SN} key corresponding to each target SN;
computing the K_{SN} key based on a SN counter value among the at least one SN counter value; and
transmitting, to the MN, a RRC reconfiguration complete message including the SN counter value used for deriving the K_{SN} key.

10. The method of claim 9, further comprising:
receiving, from the MN, a second RRC reconfiguration message including a new SN counter value for each target SN;
deleting at least one SN counter value received from the first RRC reconfiguration message; and
storing the new SN counter value received from the second RRC reconfiguration message.

11. A master node (MN) in a communication system, the MN comprising:
a transceiver; and
a controller operably coupled to the transceiver, the controller configured to:
transmit, to at least one target secondary node (SN), an SN addition request message including at least one SN counter value and K_{SN} key corresponding to each target SN, wherein each target SN includes a first target SN and a second target SN,
transmit, to a user equipment (UE), a first radio resource control (RRC) reconfiguration message including the at least one SN counter value and the K_{SN} key corresponding to each target SN, and
transmit, to the first target SN, an SN reconfiguration complete message including an SN counter value received from the UE.

12. The MN of claim 11, wherein the controller is further configured to:
receive, from the at least one target SN, an SN addition request acknowledge message including at least one algorithm information or user plane (UP) integrity and encryption information; and
receive, from the UE, an RRC reconfiguration complete message including the SN counter value,
wherein the SN counter value is used for deriving the K_{SN} key.

13. The MN of claim 11, wherein the controller is further configured to:
in case that a new key is established, derive a new SN counter value for each target SN, and
transmit, to the UE, a second RRC reconfiguration message including the new SN counter value for each target SN.

14. The MN of claim 11, wherein the MN maintains a largest SN counter value among the at least one SN counter value each of which corresponds to each target SN.

15. A first target secondary node (SN) in a communication system, the first SN comprising:
a transceiver; and
a controller operably coupled to the transceiver, the controller configured to:
receive, from a master node (MN), an SN addition request message including at least one SN counter value and K_{SN} key corresponding to each target SN, wherein each target SN includes the first target SN and a second target SN,
transmit, to the MN, a SN addition request acknowledge message including at least one algorithm information, or user plane (UP) integrity and encryption information, and
receive, from the MN, an SN reconfiguration complete message including an SN counter value received from a user equipment (UE).

16. The first target SN of claim 15, wherein the controller is further configured to:
receive, from the MN, at least one second K_{SN} key and second SN counter value corresponding to the first target SN,
delete at least one stored SN counter value and the K_{SN} key, and
store the at least one second K_{SN} key and the second SN counter value.

17. The first target SN of claim 15, wherein the SN counter value received from the UE is used for a communication between the UE and the first target SN.

18. The first target SN of claim 15, wherein the controller is further configured to:
compute UP keys based on a smallest SN counter value among the at least one SN counter value.

19. A user equipment (UE) in a communication system, the UE comprising:
a transceiver; and
a controller configured to:
receive, from a master node (MN), a first radio resource control (RRC) reconfiguration message including at least one secondary node (SN) counter value and K_{SN} key corresponding to each target SN,
compute the K_{SN} key based on a SN counter value among the at least one SN counter value, and
transmit, to the MN, a RRC reconfiguration complete message including the SN counter value used for deriving the K_{SN} key.

20. The UE of claim 19, wherein the controller is further configured to:
receive, from the MN, a second RRC reconfiguration message including a new SN counter value for each target SN;
delete at least one SN counter value received from the first RRC reconfiguration message; and
store the new SN counter value received from the second RRC reconfiguration message.
